(19) United States
(12) Patent Application Publication
(10) Pub. No.: US 2006/0135201 A1
(43) Pub. Date: Jun. 22, 2006

(54) Mobile phone with portable storage device

(75) Inventor: Yung-Ning Tso, Taipei (TW)

Correspondence Address: BACON & THOMAS, PLLC, 625 SLATERS LANE, FOURTH FLOOR, ALEXANDRIA, VA, 22314, US

(73) Assignee: Penbex Data Systems, Inc., Taipei (TW)

(21) Appl. No.: 11/017,843

(22) Filed: Dec. 22, 2004

(51) Int. Cl. H04M 1/00

(52) U.S. Cl. 455/556.1; 455/558

(57) ABSTRACT

The invention provides a mobile telephone, which may be connected to a mobile telephone network, and is able to wirelessly communicate with a portable CD-ROM device. The mobile telephone of the invention may access an application program on a disk in the portable CD-ROM device, and further receive an access code from the mobile telephone network for comparing the access code to a SIM card in the mobile telephone to decide if the program is available for use.

### BACKGROUND OF THE INVENTION

1. Field of the Invention

The present invention relates to a mobile telephone and, more particularly, to a mobile telephone which is able to wirelessly communicate with a portable CD-ROM device.

2. Description of the Related Art

The original purpose of mobile telephones was simply to provide voice communication services for users. Now, however, mobile telephones provide many new functions, such as receiving short messages and providing digital transmission capabilities, which were developed by mobile telephone manufacturers, telephone companies and software companies. Moreover, mobile telephones can now execute software programs, such as schedule management programs or game programs.

In the prior art, in order to enable the mobile telephone to execute a game program, the mobile telephone manufacturer would build the game program into the mobile telephone, and a user could directly select a built-in function to execute the onboard game. However, the typical mobile telephone has limited memory capabilities, and so is able to store only a few game programs. Since the user cannot choose the game programs, he or she may not like all of the programs built into the mobile telephone.

In another prior art technology, a Java platform executes game programs written in the Java programming language; in other words, the user must download the Java game program to the mobile telephone via a wireless network. Although the user can chose the game programs to download, the current GPRS system for mobile telephone wireless transmissions has a limited bandwidth, and so a substantial amount of time may be required to download the Java game, which may be too expensive for the user.

Therefore, it is desirable to provide a mobile telephone which is able to wirelessly communicate with a portable CD-ROM device to mitigate and/or obviate the aforementioned problems.

### SUMMARY OF THE INVENTION

A main objective of the present invention is to provide a mobile telephone, mobile telephone network, and is able to wirelessly communicate with a portable CD-ROM device. The mobile telephone of the invention may access an application program on a disk in the portable CD-ROM device.

Another objective of the present invention is to provide a mobile telephone, receive an access code from the mobile telephone network for comparing the access code to a SIM card in the mobile telephone to determine if the program is available for use.

In order to achieve the above-mentioned objective, the mobile telephone comprises a receiving and transmitting module for receiving and transmitting signals with the mobile telephone network; a memory comprising at least one software program; and a microprocessor for executing the software program in the memory; wherein the microprocessor is able to execute the software program in the memory to achieve the following means: sending signals to the portable CD-ROM device; and receiving signals from the portable CD-ROM device, wherein the signals from the portable CD-ROM device includes data from the application program.

Other objects, advantages, and novel features of the invention will become more apparent from the following detailed description when taken in conjunction with the accompanying drawings.

### BRIEF DESCRIPTION OF THE DRAWINGS

FIG. 1 is a circuit structure drawing of a mobile telephone according to the present invention.

FIG. 2 is a schematic drawing showing the present invention executing an online game.

FIG. 3 depicts a portable CD-ROM device according to the present invention.

FIG. 4 is a circuit diagram of the portable CD-ROM device according to the present invention.

FIG. 5 is a flowchart for executing an online game according to the present invention.

FIG. 6 is another flowchart of executing an online game according to the present invention.

### DETAILED DESCRIPTION OF THE PREFERRED EMBODIMENT

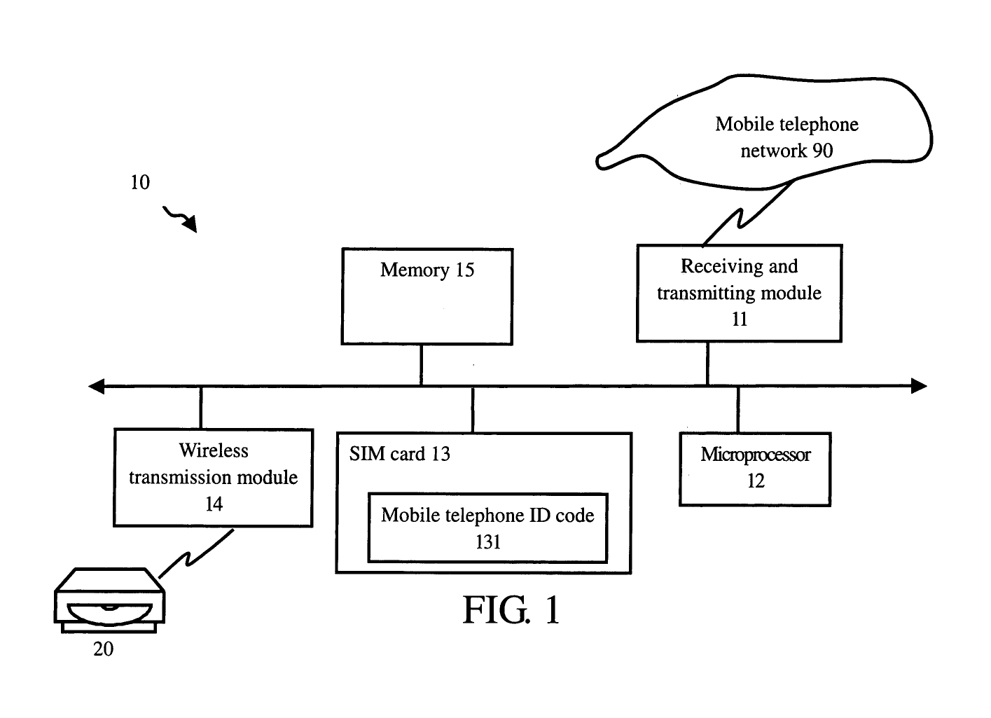

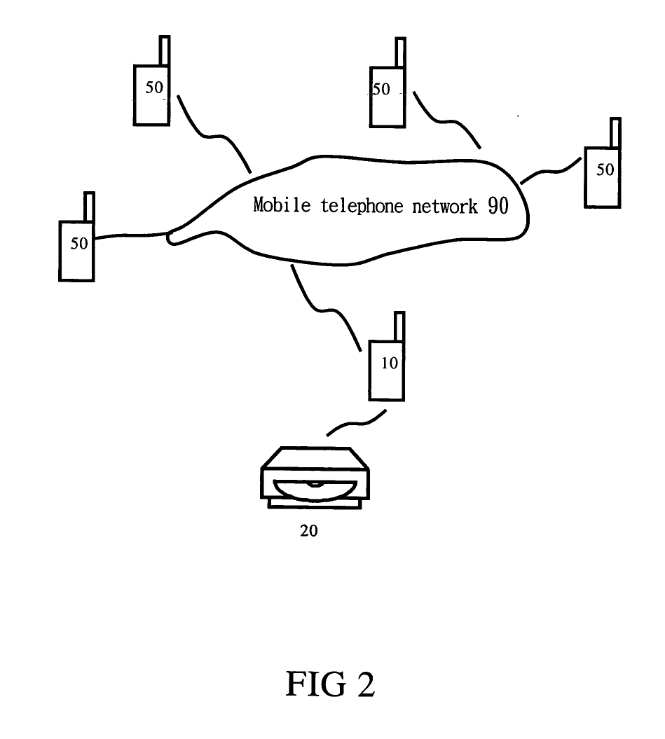

Please refer to FIG. 1 and FIG. 2. FIG. 1 is a circuit structure drawing of a mobile telephone according to the present invention. FIG. 2 is a schematic drawing showing the present invention executing an online game. As shown in FIG. 1, in an embodiment, a mobile telephone 10 has a receiving and transmitting module 11, a microprocessor 12, a SIM card 13 having a mobile telephone ID code 131, a wireless transmission module 14 and a memory 15. As in the typical mobile telephone, all elements 11, 13, 14 and 15 are electrically connected to the microprocessor 12 and controlled by the microprocessor 12. The receiving and transmitting module 11 is electrically connected to the microprocessor 12 to receive or transmit signals to a mobile telephone network 90. The SIM card 13 and the microprocessor 12 are electrically connected, and the SIM card 13 comprises a mobile telephone ID code 131 for identifying the mobile telephone 10 so that the mobile telephone network 90 can identify the mobile telephone 10 and establish a connection with it. Since the receiving and transmitting module 11 and the SIM card 13 in the present invention are well-known elements and have structures similar to the prior art structure, they require no more detailed description.

The mobile telephone 10 in the present invention differs from the prior art technology in that the mobile telephone 10 can wirelessly transmit signals to a portable CD-ROM device 20 via the wireless transmission module 14 to read an online game program or other application program stored on a CD disk that is placed within the portable CD-ROM device 20, and executes a real-time online game with other telephones 50 via the mobile telephone network 90.

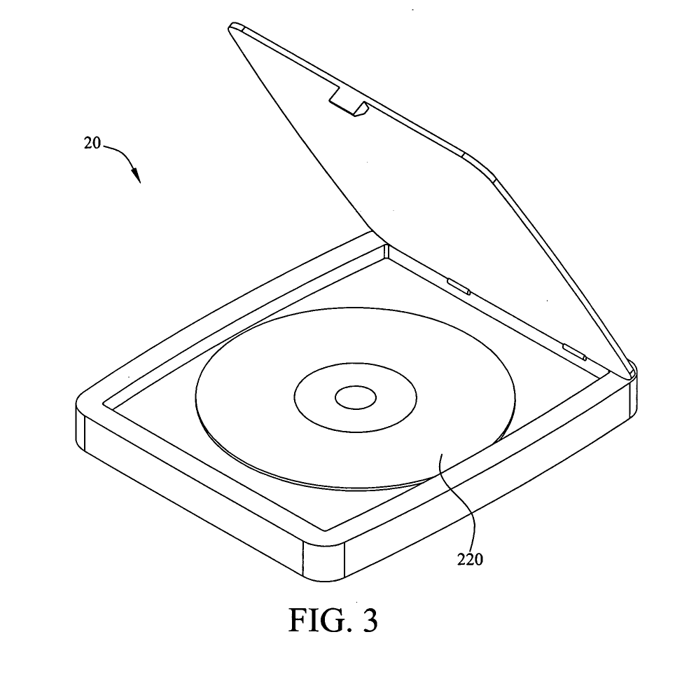

Please refer to FIG. 3. FIG. 3 illustrates a portable CD-ROM device according to the present invention. As shown in FIG. 3, the portable CD-ROM device 20 in the present invention can have the design of a prior art CD-ROM device, and so no further description is required. As shown in FIG. 3, a CD disk 220 is placed in the portable CD-ROM device 20.

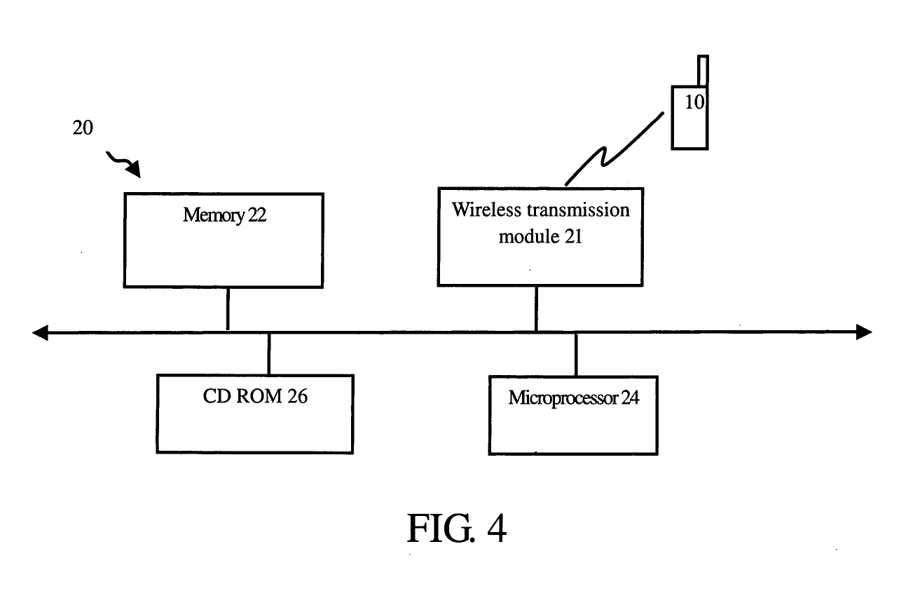

Please refer to FIG. 4. FIG. 4 is a circuit diagram of the portable CD-ROM device according to the present invention. As shown in FIG. 4, in this embodiment, the portable CD-ROM device 20 has a wireless transmission module 21, a CD reader 26 (for reading data on the CD disk), a microprocessor 24, and a memory 22 (which stores programs, and which can be integrated with the microprocessor 24). The microprocessor 24 and the wireless transmission module 21 are electrically connected to the memory 22, and the microprocessor 24 is able to execute the programs stored in the memory 22 to control the wireless transmission module 21 to receive signals from the mobile telephone 10 and also to transmit signals to the mobile telephone 10.

Consequently, the portable CD-ROM device 20 enables the mobile telephone 10 to wirelessly execute the online game program, or other application program (such as a language learning program), on the CD disk 220 placed in the portable CD-ROM device 20. Since the portable CD-ROM device 20 can be carried in a backpack or a handbag, a user can use the mobile telephone 10 to wirelessly execute the online game program, or other application program, on the CD disk 220 at any time. Furthermore, when the mobile telephone 10 executes the online game program on the CD disk 220, which is placed within the portable CD-ROM device 20, the user can play a real-time online game with other mobile telephones 50 via the mobile telephone network 90 (as shown in FIG. 1 and FIG. 2).

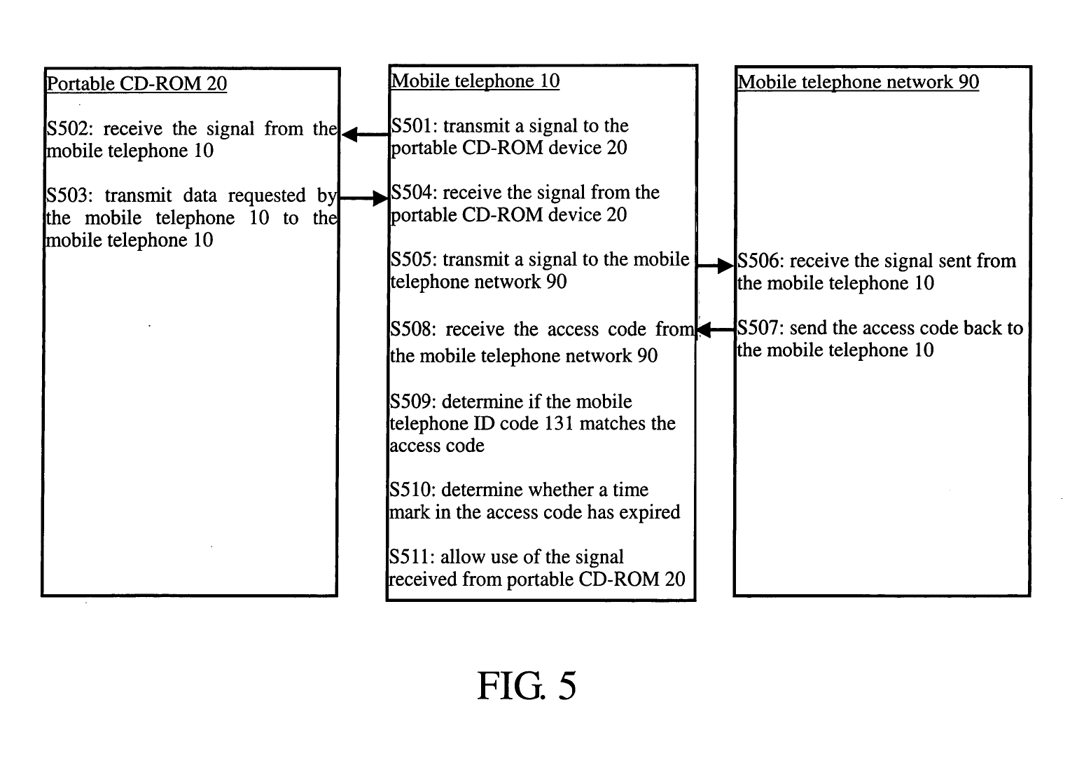

Next, please refer to FIG. 5. FIG. 5 is a flowchart of the mobile telephone 10 executing the online game according to the present invention. As shown in FIG. 5, when the user wants to play an online game on the mobile telephone 10, the mobile telephone 10 executes step S501 to transmit a signal to the portable CD-ROM device 20 to request reading of the application program stored on the CD disk 220 that was placed in the portable CD-ROM device 20. In step S502, the portable CD-ROM device 20 receives the signals from the mobile telephone 10, and in step S503, according to the signals sent by the mobile telephone 10, the portable CD-ROM device 20 transmits data requested by the mobile telephone 10 to the mobile telephone 10 via wireless signals; these signals include signals for communication with the mobile telephone 10 and data from the application program stored on the CD disk 220. The mobile telephone 10 executes step S504 to receive the signals from the portable CD-ROM device 20; the data obtained from the application program can be an executable file for a software game, application data for the software program, or other educational software.

The wireless transmission technology used between the mobile telephone 10 and the portable CD-ROM device 20 may be a well-known wireless transmission technology, such as Bluetooth, Infrared Wireless, Home Radio Frequency, or IEEE 802.11. Consequently, no further description for these wireless transmission technologies is required; however, the present invention can also utilize a cable replacement to receive and transmit the signals.

The above-mentioned steps create a connection between the mobile telephone 10 and the portable CD-ROM device 20, but in order to legally use the application program on the CD disk 220, the following steps are used to check or establish a fee processing means.

In step S505, the mobile telephone 10 transmits a signal to the mobile telephone network 90 to request an access code related to authorization. In step S506, the mobile telephone network 90 receives the signal sent from the mobile telephone 10; the mobile telephone network 90 begins to process this request. For example, the mobile telephone network 90 sends this request to a corresponding server (for example, a website, not shown), and then the server sends the access code to the mobile telephone network 90. Next, in step S507, the mobile telephone network 90 sends the access code back to the mobile telephone 10, and in step S508, the mobile telephone 10 receives the access code. In step S509, the mobile telephone 10 determines if the mobile telephone ID code 131 matches the access code, which also means that the access code includes data about the ID code 131 (which can be encoded data). If the mobile telephone ID code 131 matches, step S510 is executed. Because the mobile telephone ID code 131 is an exclusive ID code, even if the CD disk is a pirated disk, it still cannot be used without the access code.

In step S510, the mobile telephone 10 further determines whether a time mark in the access code has expired, which means that the access code also includes data for date usages (which can be encoded data). If the time mark has not expired, step S511 is executed to allow use of the signal (i.e., application program) received from portable CD-ROM device 20 in step S504. For example, if it is an executable file for a game that is being received, the executable file will be executed.

Of course, for steps S505 to S510, these steps of determining whether step S511 may be performed, or the data on the portable CD-ROM device 20 may be used, can be performed first, and then step S501 to step S504 are performed, and step S511 will then be the last step to be performed.

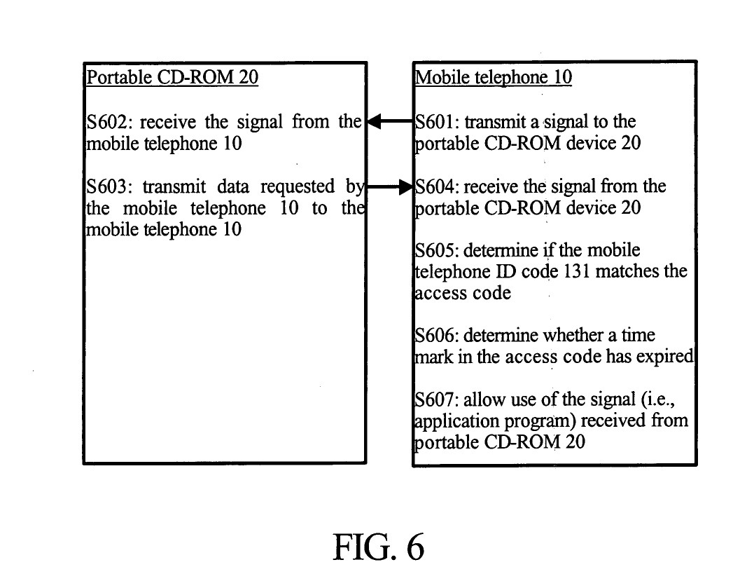

In fact, in step S508, after the mobile telephone 10 has received the access code, it can store the access code in the SIM card 13 (or other memory in the mobile telephone 10), and therefore remove the need of obtaining the access code from the mobile telephone network 90 each time. As shown in FIG. 6, step S601 to step S604 are identical to steps S501 to S504. Step S605 and step S606 compare the access code and the time mark, as in steps S509 to S510, and then step S607 is executed (just as step S511 is). Similarly, as the flowchart in FIG. 5 shows, step S605 and step S606 can be performed before steps S601 to S604.

Additionally, the access code may also include additional data, such as code name data for the application program, which is used for indicating which application program on the CD disk 220 may be used. Finally, the above-mentioned steps are achieved by executing software (such as one of the software programs stored in the memory 15 or the memory 22).

Although the present invention has been explained in relation to its preferred embodiment, it is to be understood that many other possible modifications and variations can be made without departing from the spirit and scope of the invention as hereinafter claimed. For example, the portable CD-ROM device of the present invention can be replaced by a portable hard disk having the same wireless functionality.

What is claimed is:

1. A mobile telephone capable of connecting to a mobile telephone network and capable of wirelessly communicating with a portable CD-ROM device, the portable CD-ROM device capable of reading a CD disk having at least one application program, the mobile telephone comprising:
a receiving and transmitting module for receiving and transmitting signals with the mobile telephone network;
a microprocessor;
a SIM card electrically connected to the microprocessor, wherein the SIM card comprises a mobile telephone ID code for identifying the mobile telephone;
a wireless transmission module electrically connected to the microprocessor for transmitting signals to the portable CD-ROM device; and
a memory electrically connected to the microprocessor, wherein the memory comprises at least one software program;
wherein the microprocessor is able to execute the software program in the memory to achieve the following means:
sending signals to the portable CD-ROM device; and
receiving signals from the portable CD-ROM device, wherein the signals from the portable CD-ROM device includes data from the application program.

2. The mobile telephone as claimed in claim 1, wherein the application program is a game program.

3. The mobile telephone as claimed in claim 1, wherein the application program is an online game program, and signals sent or received by the receiving and transmitting module includes signals generated by the online game program.

4. The mobile telephone as claimed in claim 1, wherein the microprocessor further executes the software program to achieve the following means: receiving an access code sent by the mobile telephone network, wherein the access code is used for determining whether the application program in the CD disk can be used.

5. The mobile telephone as claimed in claim 4, wherein when determining whether the application program in the CD disk can be used, the mobile telephone ID code and the access code are compared to each other.

6. The mobile telephone as claimed in claim 4, wherein the access code further comprises a time mark so that when determining whether the application program in the CD disk can be used, the time mark is also checked.

7. A portable data storage device for performing wireless communications with a mobile telephone, the mobile data storage device comprising:
a wireless transmission module for receiving and transmitting signals to the mobile telephone;
a reading device for reading data in the portable data storage device;
a memory comprising a program;
a microprocessor electrically connected to the wireless transmission module and the memory and being capable of executing the program in the memory to complete following means:
receiving a signal from the mobile telephone; and
transmitting a signal to the mobile telephone.

8. The portable data storage device as claimed in claim 7, wherein the portable data storage device is a portable CD-ROM device.

9. The portable data storage device as claimed in claim 7, wherein the portable data storage device is a portable hard disk.

10. A method of utilizing a mobile telephone to execute an application program, the mobile telephone capable of connecting to a mobile telephone network and performing wireless communications with a portable CD-ROM device, a CD disk capable of being placed in the portable CD-ROM device, the mobile telephone comprising a SIM card, the SIM card comprising a mobile telephone ID code for identifying the mobile telephone, the application program being stored on the CD disk, the method comprising:
reading the application program on the CD disk for the mobile telephone;
transmitting signals from the mobile telephone to the mobile telephone network to obtain an access code; and
using the access code to determine whether the application program stored on the CD disk can be used.

11. The method as claimed in claim 10 further comprising:
comparing the mobile telephone ID code and the access code with each other.

12. The method as claimed in claim 10, wherein the access code further comprises a time mark and the method further comprises
determining whether the time mark has expired.
